(19) United States
(12) Patent Application Publication
(10) Pub. No.: US 2013/0126035 A1
(43) Pub. Date: May 23, 2013

(54) ASSEMBLY OF A TUBE MADE FROM COMPOSITE MATERIAL AND A TUBULAR METAL PART

(71) Applicants: Ivica Zivanovic, Arnouville (FR); Julien Mercier, Montrouge (FR); William Lindsay Hudson, Clamart (FR); Maurice Geli, Lescar (FR)

(72) Inventors: Ivica Zivanovic, Arnouville (FR); Julien Mercier, Montrouge (FR); William Lindsay Hudson, Clamart (FR); Maurice Geli, Lescar (FR)

(73) Assignees: SOLETANCHE FREYSSINET, Rueil Malmaison (FR); TOTAL SA, Courbevoie (FR); DORIS ENGINEERING, Paris (FR); STE DES FIBRES DE CARBONE, Abidos (FR)

(21) Appl. No.: 13/807,524

(22) PCT Filed: Jul. 4, 2011
(86) PCT No.: PCT/FR11/51565

§ 371 Date: Feb. 5, 2013

(30) Foreign Application Priority Data
Jul. 2, 2010 (FR) 1055406

(51) Int. Cl. F16L 9/14

(52) U.S. Cl. CPC F16L 9/14
USPC 138/155; 29/428

(57) ABSTRACT

The invention relates to the assembly of a tube (1) made from composite material and a tubular metal part (2) in order to produce pipes. The assembly process comprises:—inserting a portion of the metal part (2) into the composite material tube (1); and—radially deforming the metal part (2) to a plastic deformation range sufficient to cause elastic deformation of said composite material tube (1), in order to obtain a radial contact between the outer wall of the metal part (2) and the inner wall of the composite material tube (1).

The present invention relates to an assembly of a tube made from composite material and a tubular metal part, for making pipes in particular in the oil production field. The pipes can be produced by connecting such assemblies by means their respective metal parts.

Tubes made from composite material can in particular be used for forming production pipes between reservoirs or wells or underwater installations and a surface production system (seabed-surface connection) as well as for water injection lines. The use of tubes made from composite material makes it possible in particular to reduce the weight of the pipe and facilitates its installation. In addition, the use of tubes made from composite material may contribute to reducing the loads on the floating structure and therefore the weight thereof.

Connection of these pipes on the surface and at the seabed must guarantee integrity of the connections under the extreme conditions to which these systems are subjected.

The document EP 0 511 138 discloses a method for the mechanical assembly of a tube made from composite material with a thermosetting matrix and a tubular metal part, in particular for offshore oil exploitation. The assembly method consists of introducing the metallic part into the tube made from composite material, and then effecting a connection by means of studs placed at regular circumferential alignments, in accordance with a specific distribution law.

One drawback of such an assembly is that only the first row of studs takes up the force, which reduces the strength of the connection.

An object of the present invention is to improve the situation.

To this end, the invention proposes a method of assembling a tube made from composite material and a tubular metal part, comprising:
inserting a portion of said metal part into said tube made from composite material,
radially deforming said metal part up to a plastic deformation range sufficient to cause elastic deformation of said tube made from composite material in order to obtain radial contact between the external wall of the metal part and the internal wall of said tube made from composite material.

The present invention thus makes it possible to produce pipes having strength in the fixing zones close to the strength of the main parts of the tubes made from composite material. In other words, the invention makes it possible to take up the tensile forces to which the pipe may be subjected without damaging the tube made from composite material, up to a value close to the rupture value of the main part of the tube, or even greater.

The connection therefore has increased strength, which improves the integrity of the connection.

Preferably, radially deforming the metal part comprises applying pressure inside said metal part, in order to cause radial expansion of said metal part.

According to one embodiment of the invention, the pressure is generated by a high-pressure hydraulic tool or by a mechanical tool.

The metal part is for example made from steel. The material of the composite tube comprises for example fibres embedded in a thermoplastic matrix or in a thermosetting matrix.

Advantageously, the method comprises, prior to inserting a portion of the metal part into the tube made from composite material, placing an adhesive or an attachment primer to the external wall of said metal part or to the internal wall of the tube made from composite material.

The method may further comprise, prior to inserting a portion of the metal part into the tube made from composite material, locally pre-deforming an end of said tube made from composite material, intended to receive said metal part, in order to create at least one radial protrusion. Then the radial deformation of said metal part further comprises a corresponding step of local deformation, so that said metal part matches the shape of said tube made from composite material.

This pre-deformation can be carried out by raising the temperature of said end of the tube made from composite material and by using a mould with a shape corresponding to the radial protrusion. A pre-deformation by raising the temperature is in particular suitable when the tube made from composite material is made from thermoplastic material.

The mould may comprise a part external to the composite tube and a part internal to the composite tube making it possible to impose deformation by pressurisation and to maintain the shape obtained after deformation until the composite tube is cooled.

The method may further comprise, prior to inserting a portion of the metal part into the tube made from composite material, machining the internal wall of the metal part in order to increase the friction coefficient between the tube made from composite material and the metal part.

The method may further comprise fitting an external confinement part, for example made from metal, around the tube made from composite material and the internal metal part. The external part contributes to the strength of the assembly. This contribution may optionally be reinforced by an active clamping system.

The clamping part is preferably placed on the composite tube prior to the local pre-deformation optionally carried out on the composite tube. The elastic shrinking of the clamping part increases the clamping of the composite tube, whereby this shrinking can be obtained during the discharge of the pressure applied to cause the radial deformation of the tubular metal part or by a deformation applied directly to the clamping part. A variant consists of arranging clamping keys between the clamping part and the tube made from composite material.

One end of the tubular metal part may comprise at least one gasket.

The invention also relates to an assembly of a tube made from composite material and a tubular metal part obtained by the aforementioned method.

The invention also relates to a pipe comprising a first assembly as aforementioned, and at least one second assembly, similar to the first assembly, connected to the first assembly. The connection between the assemblies may comprise a welding of the respective ends of the metal parts of the assemblies. The connection between the assemblies may also comprise a screwing or banding of the metal ends.

Other features and advantages of the invention will also emerge from a reading of the following description. This is purely illustrative and must be read with regard to the accompanying drawings, in which:

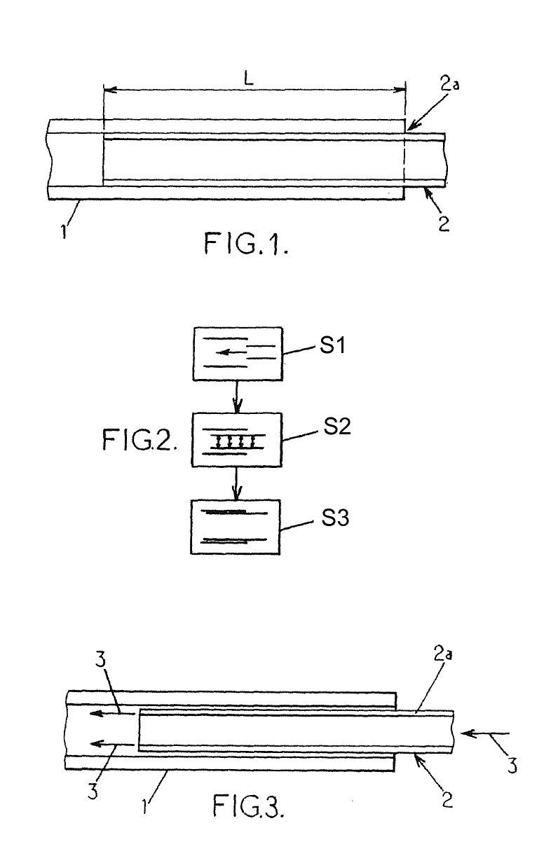

FIG. 1 is a simplified schematic view in longitudinal partial section of an assembly of a tube made from composite material and a metal tube according to one embodiment of the invention;

FIG. 2 is a flow diagram illustrating the steps of an assembly method according to one embodiment of the invention;

FIG. 3 is a view similar to FIG. 1 showing a step of the assembly;

FIG. 4 is a view similar to FIG. 1 showing another step of the assembly;

FIGS. 5 and 6 are views similar to FIG. 1 showing alternative embodiments of the assembly;

FIG. 7 is a simplified schematic view showing a connection between two elementary sections, each elementary section consisting of an assembly of a tube made from composite material and a metal tube;

FIG. 8 is a view similar to FIG. 7 showing an alternative connection between two elementary sections;

FIG. 9 is a view similar to FIG. 1 showing an alternative embodiment of the assembly.

FIG. 1 shows an assembly of a tube made from composite material 1, referred to hereinafter as a composite tube, and a tubular metal part 2, hereinafter referred to as a metal tube.

The composite material of the tube 1 is for example produced from fibres embedded in a thermosetting or thermoplastic matrix. The composite material may in particular comprise carbon fibres and/or glass fibres.

The metal tube 2 is for example produced from steel.

Hereinafter, the assembly of a composite tube 1 with a metal tube 2 will be referred to as an elementary section.

Referring to FIG. 2, a description is given of an embodiment of the method of assembling the composite tube 1 and the metal tube 2 in order to form an elementary section able to be connected to other similar elementary sections in order to form a pipe.

At step S1, the metal tube 2 is inserted into the composite tube 1 as symbolised by the arrows 3 in FIG. 3. The initial outside diameter of the metal tube 2 is slightly less than the inside diameter of the composite tube 1 in order to allow this insertion.

The metal tube 2 is inserted in the composite tube 1 over a length L (FIG. 1). The length L is chosen so that the connection area of the composite tube 1 is sufficiently strong, preferably at least as strong as the main part of the composite tube 1.

The metal tube 2 comprises a portion 2a projecting from the composite tube 1. The portion 2a forms a connecting piece to enable the elementary section to be connected with another elementary section.

At step S2, pressure is applied inside the metal tube 2. Step S2 can be performed by means of a mechanical or high-pressure hydraulic tool comprising for example an elongate-shaped cushion to be inserted inside the metal tube 2 and a pump for sending a hydraulic fluid, which may in particular be water or oil, at high pressure into the cushion.

The metal tube 2 is subjected to an internal pressure deforming it radially up to a plastic deformation range, while remaining below the rupture limit of the metal. The radial deformation is symbolised by the arrows 4 in FIG. 4.

The external wall of the metal tube 2 then comes into contact with the internal wall of the composite tube 1, which generates a radial force at the interface between the two tubes 1, 2. The external wall of the metal tube 2 thus acts on the internal wall of the composite tube 1 under traction, which causes an elastic deformation of the composite tube 1.

At step S3, the internal pressure is eliminated and the mechanical or hydraulic tool is removed from the metal tube 2. The metal tube 2 and the composite tube 1 do not return to their initial position since the high internal pressure imposed at step S2 has led to a deformation in the plastic range of the metal, i.e. to an irreversible deformation.

The metal tube 2 and the composite tube 1 nevertheless shrink slightly. The duration of step S2 and the pressure imposed are determined so that, despite this slight shrinking, the assembly of the metal tube 2 and of the composite tube 1 has sufficient strength. For example, step S2 may be parameterised so as to enable the composite tube 1 to reach a state close to its elastic limit.

The final state of the assembly is shown in FIG. 1. The metal tube 2 is acted on under compression and the composite tube 1 is acted on under traction, because of the arrangement of the fibres of the composite tube 1. The mechanical connection between the composite tube 1 and the metal tube 2 is therefore ensured by virtue of a residual radial force at the interface of the two tubes 1, 2. This radial force enables a connection withstanding the traction and bending forces.

The dimensions and parameters are determined according to the required characteristics. Values for a particular embodiment of the assembly with a composite tube 1 having an inside diameter of approximately 160 mm and a thickness of approximately 15 mm are given below by way of non-limitative example. The length L is around 1 m. The portion 2a has a length of around 30 cm to 50 cm.

The pressure applied at step S2 is around 300 MPa. The radial force at the interface between the two tubes 1, 2 is around 100 MPa. The radial movement of the interface during step S2 is approximately 1.6 mm. And the shear stress at the external surface of the composite tube 1 is around 40 MPa.

After step S3, the residual radial force is around 74 MPa, the radial movement of the interface is approximately 1.2 mm and the shear stress at the external surface of the composite tube 1 is approximately 30 MPa.

Optionally, to increase the strength of the connection, which depends on the adhesion between the two tubes 1, 2, a fixing product, for example an adhesive or an attachment primer, may be placed between the external wall of the metal tube 2 and the internal wall of the composite tube 1. The fixing product is applied to the external wall of the metal tube 2 before its insertion into the composite tube 1, or on the internal wall of the composite tube 1.

Adhesion may also be increased by machining the external wall of the metal tube 2, for example in order to produce a rough surface finish, serrations or a profile of the thread type. Such machining affords better mechanical indentation of the parts in contact.

The strength of the connection may also be increased by locally modifying the profile of the composite tube 1 in order to form a radial protrusion 5 on the tube 1, a shown in FIG. 5. The metal tube 2 is then also deformed locally in order to form a radial protrusion 6 cooperating with the protrusion 5. The local deformation, also referred to as re-forming, increases the strength of the connection.

FIG. 6 shows an alternative embodiment of a local deformation of the profiles of the tubes 1, 2.

The local modification of the profile of the composite tube 1 can also be effected by increasing the temperature of the end of the tube 1 in order to reach a temperature of around 200° C. for a thermoplastic tube with a polyamide matrix, and by the use of a mould with a specific shape corresponding to the required deformation. The mould makes it possible to cause the deformation through the inside of the composite tube by pressurisation and maintenance of this deformation during the cooling phase.

The strength of the connection can also be increased by placing an external metal confinement part, for example made from steel, around the composite tube 1 and the metal tube 2. The part comprises a passage hole for the tube 1, for example cylindrical or conical in shape, or with a shape adapted to the shape of the composite tube 1. The external part contributes to the strength of the assembly, by making it possible in particular to achieve clamping by friction by applying an external residual force through the elastic contraction of the metal part. This contribution may optionally be reinforced by an active clamping system, for example by interposing clamping keys between the composite tube 1 and the part.

The present invention thus makes it possible to produce elementary sections intended to be connected together to produce very long pipes. The assembly method according to the invention makes it possible to obtain a strength in the fixing zone close to the strength of the main part of the tube 2, or even greater.

Referring to FIG. 7, the connection between two elementary sections can for example be achieved by welding the free ends of two connecting pieces 2a. Alternatively, the connection can be made by means of a connector 8 (FIG. 8) placed between the two connection pieces 2a. The connection can also be made by screwing or banding the connecting pieces (2a).

A gasket 9 (FIG. 9) can be placed at the end of the metal tube 2 intended to be inserted into the composite tube 1 in order to achieve supplementary sealing at the interface between the metal tube 2 and the composite tube 1. Alternatively, several gaskets can be fitted at the end of the metal tube 2.

As shown in FIG. 9, the shape of the metal tube 2 can be adapted to attenuate the stresses in the composite tube 1 at the end 10 of the metal tube 2. To attenuate the stresses, the end 10 of the tube 2 has for example a bevel or rounded shape. The pressurisation is then effected on a delimited zone not comprising the end 10.

The present invention has been described and illustrated in the present detailed description and in the figures. The present invention is not limited to the embodiments presented. Other variants and embodiments can be derived and implemented by a person skilled in the art from a reading of the present description and the accompanying figures.

1. A method of assembling a tube made from composite material and a tubular metal part, comprising:
inserting a portion of said metal part into said tube made from composite material,
radially deforming said metal part up to a plastic deformation range sufficient to cause elastic deformation of said tube made from composite material in order to obtain radial contact between the external wall of the metal part and the internal wall of said tube made from composite material.

2. The method of claim 1, wherein radially deforming the metal part comprises applying pressure inside said metal part in order to cause radial expansion of said metal part

3. The method of claim 2, wherein said pressure is generated by a high-pressure hydraulic tool or by a mechanical tool.

4. The method of claim 1, wherein said metal part is made from steel.

5. The method of claim 1, wherein the composite material of said tube made from composite material comprises fibres embedded in a thermoplastic matrix or a thermosetting matrix.

6. The method of claim 1, further comprising, prior to inserting the portion of said metal part into said tube made from composite material:
placing an adhesive or attachment primer on an external wall of said metal part or on an internal wall of the tube made from composite material.

7. The method of claim 1, further comprising, prior to inserting the portion of said metal part into said tube made from composite material:
pre-deforming locally an end of said tube made from composite material, intended to receive said metal part, in order to create at least one radial protrusion,
wherein radially deforming said metal part further comprises a corresponding step of local deformation, so that said metal part matches a shape of said tube made from composite material.

8. The method of claim 7, wherein the local pre-deformation of the end of said tube made from composite material is effected by raising the temperature of said end of the tube made from composite material and by using a mould having a shape corresponding to the radial protrusion.

9. The method of claim 1, further comprising, prior to inserting a portion of said metal part into said tube made from composite material, machining an internal wall of said metal part in order to increase a friction coefficient between the tube made from composite material and said metal part.

10. The method of claim 1, further comprising placing an external confinement part around the tube made from composite material and the internal metal part.

11. The method of claim 10, wherein a clamping system is placed on the external confinement part.

12. The method of claim 1, wherein one end of said tubular metal part comprises at least one gasket.

13. An assembly, comprising a tube made from composite material and a tubular metal part, wherein a portion of said metal part is inserted in said tube made from composite material, and said metal part has been radially deformed up to a plastic deformation range sufficient to cause elastic deformation of said tube made from composite material in order to obtain radial contact between the external wall of the metal part and the internal wall of said tube made from composite material.

14. A pipe, comprising a first assembly and at least one second assembly connected to said first assembly,
wherein each of the first and second assemblies has a respective tube made from composite material and a respective tubular metal part, wherein a portion of said metal part is inserted in said tube made from composite material, and said metal part has been radially deformed up to a plastic deformation range sufficient to cause elastic deformation of said tube made from composite material in order to obtain radial contact between the external wall of the metal part and the internal wall of said tube made from composite material.

15. The pipe of claim 14, wherein the connection between the first and second assemblies comprises a welding of respective ends of the metal parts of the first and second assemblies.

16. The pipe of claim 14, wherein the connection between the first and second assemblies comprises a screwing or banding of the respective metal parts.
